(19) United States
(12) Patent Application Publication
(10) Pub. No.: US 2005/0028593 A1
(43) Pub. Date: Feb. 10, 2005

(54) Method and apparatus for high sensitivity monitoring of molecular contamination

(75) Inventor: Daniel Rodier, Louisville, CO (US)

Correspondence Address: PATTON BOGGS, 1660 LINCOLN ST, SUITE 2050, DENVER, CO, 80264, US

(73) Assignee: Particle Measuring Systems, Inc., Boulder, CO (US)

(21) Appl. No.: 10/634,464

(22) Filed: Aug. 4, 2003

(51) Int. Cl. G01G 3/16

(52) U.S. Cl. 73/580; 310/313 R

(57) ABSTRACT

A device for monitoring molecular contamination includes a measurement element comprising a high surface area material having a surface area greater than 100 square meters per gram, and a sensing circuit connected to the measurement element and providing an output signal characteristic of molecular contamination on the surface of the material. The high surface area material can be an aerogel, carbon, activated carbon, a polymer based on diphenyl p-phenylene oxide, silica, a resorcinol-formaldehyde organic polymer, alumina, or a nanocellular carbon foam or other material. The high surface area material can be doped with a specific molecule which interacts with a particular contaminant molecule.

### BACKGROUND OF THE INVENTION

1. Field of the Invention

The present invention relates to real-time monitoring of chemical and physical interactions between gases and solid surfaces for purposes including detection of airborne molecular contaminants pertaining to manufacturing and processing environments.

2. Statement of the Problem

Many manufacturing processes and technologies are susceptible to airborne or gas-phase molecular contaminants (AMC), and to the related surface molecular contamination (SMC) resulting from chemical interactions between AMC and critical surfaces exposed to the same. Such critical surfaces, called “subject surfaces” herein, are, for example: integrated circuit surfaces, such as resist, silicon, and other semiconductors; wiring surfaces made of tungsten, aluminum, or other metals; silicon dioxide surfaces; optical surfaces; mechanical surfaces; surfaces of hard disks; surfaces of flat panel displays; etc. Detrimental effects of SMC include, for example, changes in the chemical, electrical, and optical qualities of critical surfaces. These detrimental effects decrease product performance and reliability and raise product costs. Some examples of such detrimental effects to the above-mentioned critical surfaces include T-topping of resist—an anomaly that undercuts line geometries and leads to device failures and yield reductions; defective epitaxial growth; unintentional doping; uneven oxide growth; changes in wafer surface properties; corrosion; and decreased metal pad adhesion. Many of these effects become particularly detrimental as line widths smaller than 0.13 microns become commonplace. Further, as wafer sizes increase and as device geometry decreases, the demand for more sensitive monitoring techniques will increase. In the optics industry, SMC is a well-known cause of hazing of optical surfaces. SMC also causes friction problems in certain mechanical devices, such as hard disk drives, since SMC-contaminated surfaces may have a significantly higher coefficient of friction than uncontaminated surfaces. SMC also affects the manufacture of hard disk drives and flat panel displays, which, for reasons known in the art, are typically carried out in a plurality of “mini” clean rooms.

The various AMCs causing detrimental SMC may be grouped into four general categories: acids, bases, condensables, and dopants, otherwise referred to as SEMI F21-95 Classes A, B, C, and D. Some AMCs, though, are of no particular class.

Sources for AMC include inadequate filtration of recirculated air; cross-process chemical contamination; outgassing of cleanroom materials, such as filters, gel sealants, and construction materials; as well as contaminants carried in and exuded by human beings. When the fluid is outdoor “make-up” air, the sources of AMC include automobile exhaust, evapotranspiration from plants, and various industrial emissions. AMC also includes chemical compounds and vapors resulting from chemical breakdown of, and interaction between, the molecules within the AMC from the primary sources. Other sources of AMC/SMC include cross-process chemical contamination within a bay or across a facility, and recirculated air with inadequate ventilation. Still other sources include outgassing by cleanroom materials, such as filters, gel sealants, and construction materials, especially new fabrics; and various contaminants emanating from industrial equipment, such as pumps, motors, robots, and containers. Yet other sources include accidents, including chemical spills, and upsets in temperature and humidity controls. Still another source is people, including their bodies, clothes, and their personal care products.

AMC can cause yield losses even when present at concentrations as low as subparts per billion by volume (“ppbv”). Such processes therefore require an ultra-clean, well-monitored environment. Moreover, in addition to maintaining the processing environment at a high level of cleanliness over extended time periods, even brief contamination events should be prevented.

An important limitation on the performance of existing monitoring technologies is their ability to measure brief contamination events, which ability is limited by their mass sensitivity. Generally, mass sensitivity is proportional to the square of the operating frequency of an SMC sensor, where increasing sensitivity corresponds to a smaller number for mass sensitivity when measured in units of grams over the product of hertz and square centimeters (g/(cm²·Hz)).

Existing SMC sensors offer a range of operating frequencies and associated mass sensitivities. Existing quartz crystal microbalance (QCM) sensors typically operate between 4 megahertz (MHz) and 12 MHz and generally provide a low-cost, low-sensitivity approach. Existing surface acoustic wave (SAW) sensors operate at 200 MHz or more, are more sensitive than QCM sensors, but are also typically more expensive than their QCM counterparts. A SAW monitoring system is described in U.S. patent application Ser. No. 10/178,699, entitled “Method And Apparatus For Monitoring Molecular Contamination Of Critical Surfaces Using Coated SAWS”, filed Jun. 24, 2002, the disclosure of which is incorporated herein by reference. Thus, increasing the operating frequency of SMC sensors is one way to achieve the desired increased mass sensitivity. However, the cost of sensors and the electronic equipment supporting the sensors generally increases with increasing sensor frequency.

### Solution

The present invention advances the art and overcomes the aforementioned problems by providing a measurement element, made of a high surface area material such as aerogel, in combination with an SMC sensing circuit. Preferably, the high surface area material is connected to a sensing circuit, which circuit preferably provides an output signal characteristic of molecular contamination on the surface of the high surface area material.

The high surface area measurement element may be deployed in combination with a QCM sensing circuit, thereby providing mass sensitivity normally available only with much more expensive sensors. Alternatively, where particularly high mass sensitivity is desired, the high surface area measurement element may be deployed on a SAW sensing circuit, thereby providing mass sensitivities surpassing any available in the existing SMC monitoring art. Moreover, sensing circuits other than SAW and QCM sensing circuits may be employed.

Optionally, the high surface area measurement element may be used in conjunction with one or more chemically selective membranes as described in U.S. application Ser. No. 10/178,818, entitled “Molecular Contamination Monitoring System And Method”, filed Jun. 24, 2002, the disclosure of which is incorporated herein by reference. If deployed, the chemically selective membrane is preferably located in between one or more sources of molecular contamination and the high surface area measurement element.

The invention provides a device for monitoring molecular contamination, said device comprising: a measurement element comprising a material having a surface area greater than 100 square meters per gram; and a sensing circuit connected to said measurement element and providing an output signal characteristic of molecular contamination on the surface of said material. Preferably, said material comprises an aerogel. Preferably, said material comprises carbon. Preferably, said material comprises activated carbon. Preferably, said material comprises a polymer based on diphenyl p-phenylene oxide. Preferably, said material comprises silica. Preferably, said material comprises a resorcinol-formaldehyde organic polymer. Preferably, said material comprises alumina. Preferably, said material comprises a nanocellular carbon foam. Preferably, said material is more than 100 nm thick. Preferably, said material is less than 10 microns thick. Preferably, said material has a surface area concentration above 400 m²/g. Preferably, said material has a surface area concentration above 1000 m²/g. Preferably, said material has a surface area concentration above 1500 m²/g. Preferably, said measurement element includes a piezoelectric crystal having a detecting surface and said material is formed on said detecting surface. Preferably, said sensing circuit comprises a surface wave acoustic (SAW) sensor circuit. Preferably, said sensing circuit comprises a quartz crystal microbalance (QCM) sensor circuit. Preferably, the device further comprises a chemically selective membrane located between a source of said molecular contaminant and said material.

According to another aspect, the invention provides a method of monitoring molecular contamination, said method comprising: providing a measurement element comprising a material having a surface area greater than 100 square meters per gram; collecting molecular contamination on said surface area; and electronically detecting said molecular contamination. Preferably, said electronically detecting comprises exciting an acoustic wave in said measurement element.

According to yet another aspect, the invention provides a method for monitoring molecular contamination, the method comprising: providing a piezoelectric sensor; locating a high-surface-area measurement element on said piezoelectric sensor; and detecting a molecular contaminant on said measurement element. Preferably, said detecting comprises generating an electrical signal indicative of an accumulated quantity of said received molecular contaminant on said measurement element. Preferably, said detecting comprises exciting an acoustic wave in said piezoelectric sensor. Preferably, said detecting comprises exciting an acoustic wave on the surface of said piezoelectric sensor. Preferably, the method further comprises inhibiting contaminants other than a selected molecular contaminant from reaching said measurement element.

Numerous other features, objects and advantages of the invention will become apparent from the following description when read in conjunction with the accompanying drawings.

### BRIEF DESCRIPTION OF THE DRAWINGS

FIG. 1 is a perspective view of a measurement element located adjacent to a sensing circuit according to a preferred embodiment of the present invention;

FIG. 2A is a perspective view of a selective membrane located adjacent to the measurement element of FIG. 1;

FIG. 2B is a perspective view of a selective membrane located spaced from the measurement element of FIG. 1;

FIG. 3 is a perspective view of an exemplary SAW device;

FIG. 4 shows an exemplary detection apparatus having a SAW device according to the FIG. 3 example; and

FIG. 5 shows an exemplary detection apparatus according to FIG. 4 further including a reference SAW.

### DETAILED DESCRIPTION OF THE PREFERRED EMBODIMENT

In this disclosure, a “planar surface area” is the surface area of one extremity of an object defining a plane. A “planar surface area” does not include the area of surfaces in an interior portion of a material or object. “Surface area concentration” is the numerical measure of the amount of surface area per unit mass of a high surface area material and is expressed herein in units of square meters per gram. An “effective surface area” is the total surface area of the relevant element of high surface area material. In contrast to planar surface area, effective surface area includes the area of surfaces located throughout the interior of an object or layer of material. A “sensing circuit” is a circuit that provides a signal indicative of an accumulation of contaminant material on a measurement surface. A sensing circuit preferably includes a piezoelectric sensor. Piezoelectric sensors include, but are not limited to, SAW sensors and QCM sensors. The term “fluid” is defined herein as a liquid or gas, or a vapor mixture, including air, elemental gasses such as nitrogen and argon, and mixtures of the same. When an example operation is described, the particular fluid used for the description is not, unless otherwise stated or clear from the context, intended as a limitation on the scope or operation of the invention.

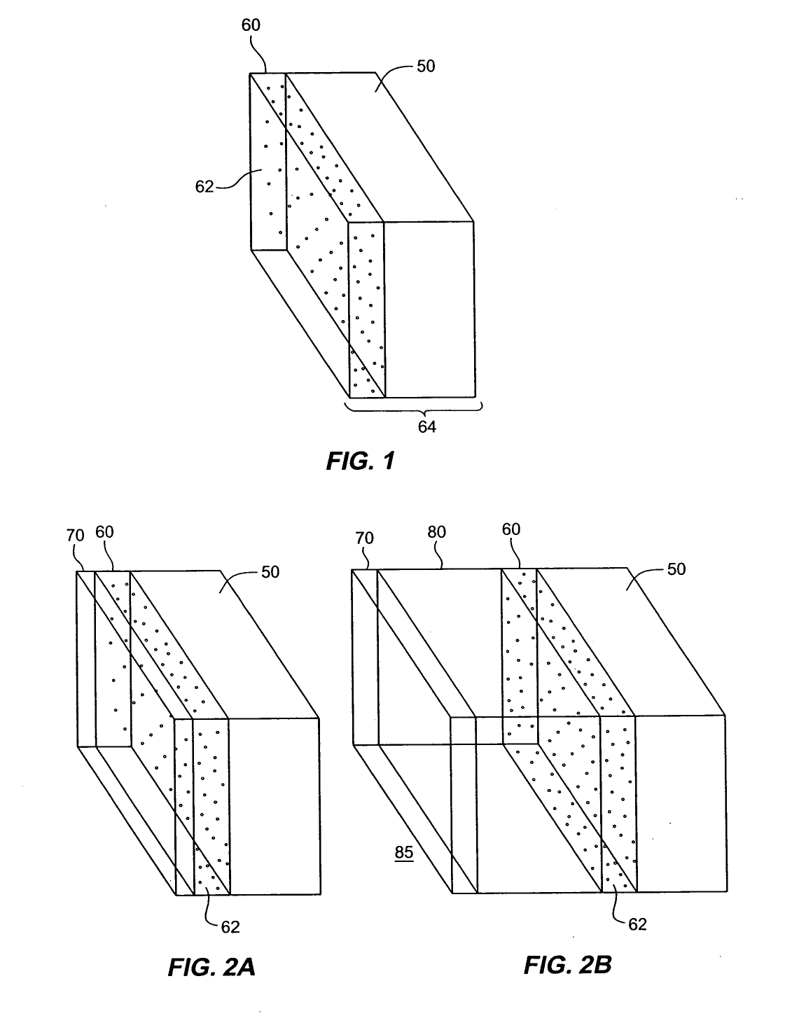

FIG. 1 is a perspective view of a measurement element 60 located adjacent to a sensing circuit 50 according to a preferred embodiment of the present invention. Sensing circuit 50 preferably includes a piezoelectric sensor, which piezoelectric sensor may be a QCM sensor or SAW sensor or other type of piezoelectric sensor. However, sensing circuit 50 is not limited to including a piezoelectric sensor.

Preferably, sensing circuit 50 has a surface contacting measurement element 60, and this contact surface preferably has a planar surface area (Aₚ). The variables relevant to determining the output of sensing circuit 50 are: the deposition rate per unit area, S; the total deposition rate, D; and the total accumulated SMC mass on the sensor, M. Sensor output is typically proportional to total accumulated SMC mass. The total deposition rate, D, is equal to the incoming molecular flux minus the outgoing or desorbing molecular flux. In some cases, the outgoing or desorbing molecular flux is negligible.

For incoming molecular flux, the deposition rate per unit area is given by:
S=E(NV/4) (1)
where S is the deposition rate in molecules/(cm²·sec); E is a dimensionless sticking coefficient having a value ranging between 0 and 1 (E depends on temperature, humidity, surface composition, and the magnitude and type of other AMC present); N is the number density in air in molecules per cubic centimeter (cm³); and V is the average thermal velocity in centimeters per second (cm/sec).

The deposition rate per unit time is given by:
D=S·A, (2)
where A is the area of the sensor surface. Accordingly, for a particular mass change event in a processing environment, the change in output of a sensing circuit arising from this event (mass sensitivity) is proportional to the sensor area, A.

Combining measurement element 60 with sensing circuit 50 provides an effective surface area many times greater than the planar surface area of sensing circuit 50. Thus, the accumulated mass affecting the output of sensing circuit 50 and the resulting mass sensitivity of sensing circuit 50 preferably increase in proportion to the increase in effective surface area. This approach advantageously increases the mass sensitivity of sensing circuit 50 without modifying either its structure or frequency of operation. Herein, the combination of sensing circuit 50 and measurement element 60 provides coated sensing circuit 64.

In the preferred embodiment, measurement element 60 is made of a high surface area material, and more preferably, an aerogel material. Aerogels are extremely low-density, high-surface-area solids having densities between about 3.5·10⁻³ (gram per cubic centimeter) g/cm³ and about 0.4 g/cm³. Because of their porosity, aerogel materials and other high surface area materials include a high level of surface area distributed throughout a finite mass of material. The concentration of surface area may be expressed in terms of surface area per unit mass (surface area concentration).

Herein, a high surface area material is a material having a surface area concentration above 100 square meters per gram (m²/g). Measurement element 60 preferably has a surface area concentration above 100 m²/g, more preferably above 400 m²/g, still more preferably above 1000 m²/g, and most preferably above 1500 m²/g. High surface area materials preferably include both aerogel and non-aerogel materials. The surface area concentration of aerogel materials varies from about 400 m²/g to about 1000 m²/g, depending on the material and the process used to create the aerogel. Some activated carbon materials have surface area concentrations of about 1600 m²/g. Commercially available aerogel materials include, but are not limited to, silica, carbon, resorcinol-formaldehyde organic polymers, alumina, and nanocellular carbon foams. Available non-aerogel materials include Tenax® GC, polymers based on 2,6 diphenyl p-phenylene oxide, and activated carbon. Methods for manufacturing the materials listed above are known in the art and are therefore not discussed herein.

Aerogel materials include the common feature of open, interconnected pores with diameters below 100 nanometers (nm). This open cell structure preferably provides access to the entire effective surface area for reaction/deposition of molecules in the gas phase.

The high surface area material, particularly the aerogels, can also be doped with specific molecules which interact with particular contaminant molecules, thereby enabling chemical selectivity in addition to enhanced sensitivity. An example of such a dopant is stearic acid which reacts with ammonia, a molecular contaminant.

In the preferred embodiment, measurement element 60 is between 100 nm and 10 microns (10,000 nm) thick. However, measurement elements having thicknesses outside this range may be used.

Examples of mass sensitivity improvement using high surface area material, preferably aerogel, follow. The first example concerns a case where sensing circuit 50 is a SAW sensing circuit operating at 200 MHz. Data is provided for sensing circuit 50 both with and without measurement element 60.

### EXAMPLE 1

### Sensing Circuit 50 is a Surface Wave Acoustic Sensor

Operating frequency: 200 MHz.
Normal sensing circuit 50 mass sensitivity: 2·10⁻¹¹ g/(cm²·Hz).
Coating mass capacity: 1·10⁻⁵ g/cm².
Sensing circuit planar surface area 54: 0.1 cm².
Effective surface area of measurement element 60: 8 cm².
Improvement in sensitivity: 80 fold.
Sensitivity of sensing circuit 50 with measurement element 60 attached: 2.5·10⁻¹³ g/(cm²·Hz).

### EXAMPLE 2

### Sensing Circuit 50 is a Quartz Crystal Microbalance Sensor

Operating frequency: 10 MHz.
Normal sensing circuit 50 mass sensitivity: 8·10⁻⁹ g/(cm²·Hz).
Coating mass capacity: 4·10⁻⁴ g/cm².
Sensing circuit 50 planar surface area 54: 1 cm².
Effective surface area of measurement element 60: 3200 cm².
Improvement in sensitivity: 3200 fold.
Sensitivity of sensing circuit 50 with measurement element 60 attached: 2.5·10⁻¹² g/(cm²·Hz).

Example 1 above indicates that the deployment of measurement element 60 can make an already sensitive SAW sensing circuit still more sensitive. Alternatively, in Example 2, the use of measurement element 60 enables a low-cost QCM sensing circuit to achieve sensitivity levels which surpass those of more expensive, existing SAW sensing circuits.

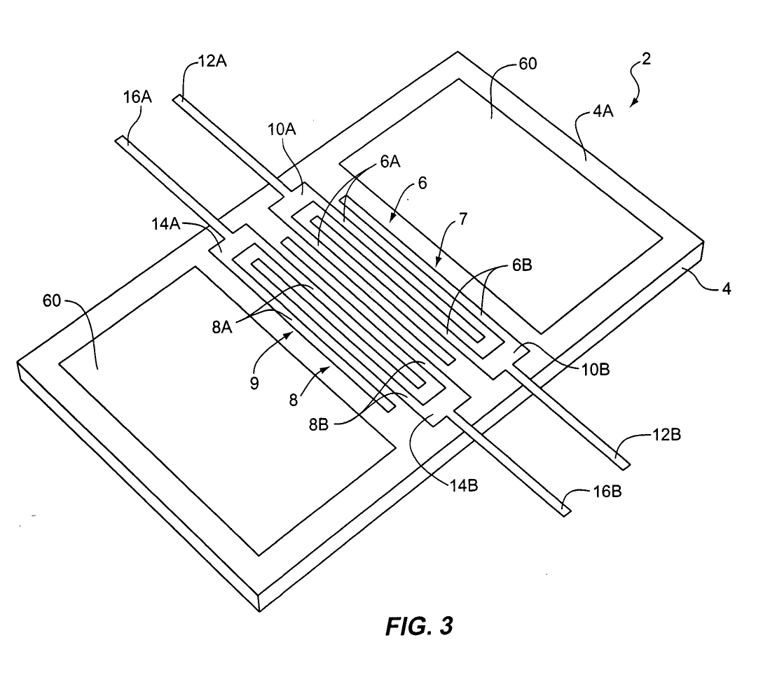

FIG. 2A is a perspective view of a selective membrane 70 located adjacent to measurement element 60, while FIG. 2B is a perspective view of a selective membrane 70 located spaced from the measurement element 60. In the embodiment of FIG. 2A, membrane 70 is formed directly on the surface of measurement element 60. In the embodiment of FIG. 2B, membrane 70 is located between sample fluid 85 and measurement element 60 with no direct physical contact between the two. A conduit 80 encloses the fluid between membrane 70 and measurement element 60. The composition and structure of chemically selective membrane 70 is preferably as described in U.S. application Ser. No. 10/178,818, entitled “Molecular Contamination Monitoring System And Method”, filed Jun. 24, 2002, which is hereby incorporated by reference as though fully disclosed herein.

The discussion of FIGS. 3-5 describes one exemplary embodiment in which sensing circuit 50 is a SAW sensing circuit. It will be appreciated, however, that the present invention is not limited to the use of SAW sensors. Other piezoelectric sensors, including QCM sensors, may be employed in place of, or in addition to, SAW sensing circuit 2 discussed in connection with FIGS. 3-5. Moreover, other piezoelectric sensors and non-piezoelectric sensors may be employed.

FIG. 3 is a perspective view of an example SAW sensing circuit 2. Preferably, sensing circuit 2 comprises a substrate 4 having a measurement surface 4A, with a first pair 6 of interdigital transducers, labeled 6A and 6B respectively, disposed on a first area 7 of surface 4A. Measurement element 60 is preferably located on surface 4A. In the embodiment of FIG. 3, measurement element 60 is located on each of two separate portions of surface 4A. However, measurement element 60 may be located on fewer than or more than two portions of a sensing circuit surface. Moreover, measurement element 60 may be distributed either continuously or discontinuously over the surface of a sensing circuit surface. In the preferred embodiment, measurement element 60 is distributed continuously and uniformly across surface 4A.

In the embodiment of FIG. 3, a second pair 8 of interdigital transducers, labeled 8A and 8B respectively, is disposed on a second area 9 of surface 4A. A first contact pad 10A connects to transducer 6A of the first pair and to a first connection line 12A. Similarly, a second contact pad 10B connects to transducer 6B of the first pair and to a second connection line 12B. A third contact pad 14A connects to transducer 8A of the second transducer pair and to a third connection line 16A. A fourth contact pad 14B connects to transducer 8B of the second transducer pair and to a fourth connection line 16B.

Measurement element 60 is preferably disposed on surface 4A over an area in which surface acoustic waves propagate in response to electric signals input to one or more of the first transducer pair 6A, 6B and the second transducer pair 8A, 8B, as described below. Measurement element 60 preferably changes the acoustic wave propagation velocity as compared to a substrate 4 without a coating on surface 4A.

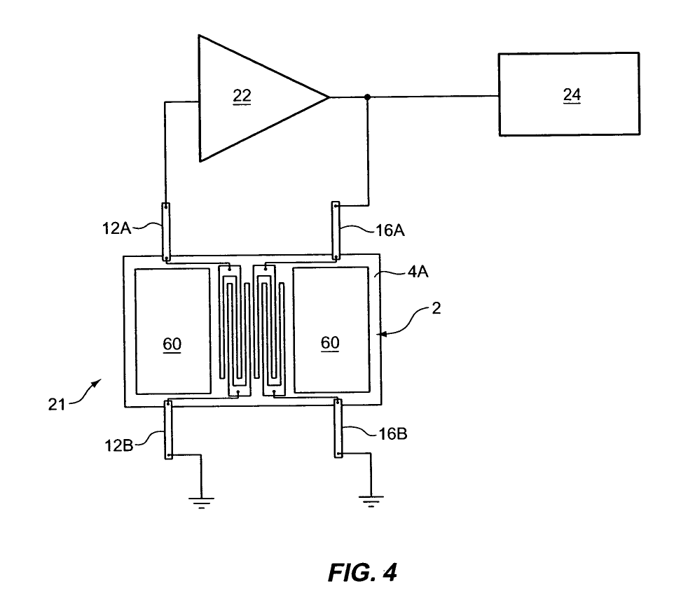

FIG. 4 shows an example SAW measurement apparatus having SAW sensing circuit 2 connected within a free-running oscillator circuit 21. In the preferred embodiment, connecting SAW sensing circuit 2, with measurement element 60 located thereon, to free-running oscillator 21 is one of the methods for detecting changes in the mass experienced by SAW sensing circuit 2 contemplated by this invention.

The FIG. 4 circuit forms a free-running oscillator circuit 21 by connecting the first and second transducer pair 6A, 6B and 8A, 8B, respectively, to amplifier 22, which is known in the prior art of SAW-based AMC detectors. Amplifier 22 may contain phase-shifting elements for desired oscillation characteristics, as is also known in the art. The oscillating frequency depends, in part, on the acoustic wave propagation velocity. The change in acoustic wave propagation velocity caused by the increased mass of measurement element 60 on surface 4A due to new molecules formed by interaction with molecular contamination therefore changes the oscillating frequency. The change in oscillator frequency is preferably detected by frequency detector 24. It will be understood that the free-running oscillator depicted in FIG. 4 is merely an example, as other SAW-based oscillator circuits are known in the art. Further details of a SAW detector circuit are given in U.S. Pat. No. 6,122,954 issued Sep. 26, 2000 to William D. Bowers and U.S. Pat. No. 4,871,984 issued Oct. 3, 1989 to Laton et al., both of which are hereby incorporated by reference as though fully disclosed herein.

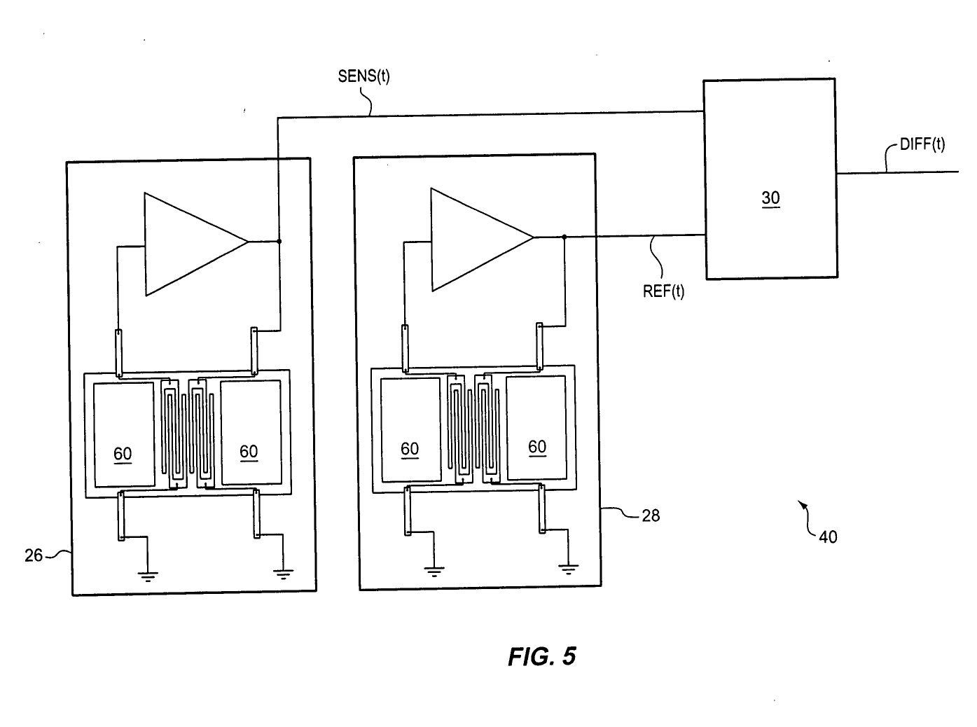

FIG. 5 shows a preferred embodiment of a molecular contamination monitor 40 according to the invention. Monitor 40 comprises SAW sensing circuit 26 having measurement element 60 exposed to an ambient fluid, and SAW sensing circuit 28, substantially identical to SAW sensing circuit 26, and preferably hermetically sealed, or exposed via chemical filter or membrane as discussed in U.S. patent application Ser. No. 10/178,818 referenced above and as is known in the art. It will be appreciated that, in one embodiment, sensing circuit 50 may be a SAW sensing circuit as are sensing circuits 26 and 28.

In this embodiment, comparator 30 preferably receives the oscillating signal SENS(t) from the detection surface SAW sensing circuit 26 and the oscillating signal REF(t) from reference SAW sensing circuit 28 and generates difference signal DIFF(t) representing the difference between the SENS(t) and REF(t) frequencies. This frequency difference is commonly referred to as a “beat frequency”. The value of DIFF(t) preferably corresponds to the increased mass of measurement element 60 on SAW sensing circuit 26. This frequency is typically on the order of half a megahertz, ranging typically from 0.3 MHz to 0.8 MHz. It will be appreciated that other types of piezoelectric sensors may be substituted for SAWs 26 and 28 in the embodiment of FIG. 6, including, but not limited to, QCM sensors. Moreover, sensing circuits other than piezoelectric sensors may be employed.

It should be understood that the particular embodiments shown in the drawings and described within this specification are for purposes of example and should not be construed to limit the invention which will be described in the claims below.

1. A device for monitoring molecular contamination, said device comprising:
a measurement element comprising a material having a surface area greater than 100 square meters per gram; and
a sensing circuit connected to said measurement element and providing an output signal characteristic of molecular contamination on the surface of said material.

2. The device of claim 1 wherein said material comprises an aerogel.

3. The device of claim 1 wherein said material comprises carbon.

4. The device of claim 1 wherein said material comprises activated carbon.

5. The device of claim 1 wherein said material comprises a polymer based on diphenyl p-phenylene oxide.

6. The device of claim 1 wherein said material comprises silica.

7. The device of claim 1 wherein said material comprises a resorcinol-formaldehyde organic polymer.

8. The device of claim 1 wherein said material comprises alumina.

9. The device of claim 1 wherein said material comprises a nanocellular carbon foam.

10. The device of claim 1 wherein said material is more than 1 nm thick.

11. The device of claim 1 wherein said material is less than 100 microns thick.

12. The device of claim 1 wherein said material has a surface area concentration above 400 m²/g.

13. The device of claim 1 wherein said material has a surface area concentration above 1000 m²/g.

14. The device of claim 1 wherein said material has a surface area concentration above 1500 m²/g.

15. The device of claim 1 wherein said measurement element includes a piezoelectric crystal having a detecting surface and said material is formed on said detecting surface.

16. The device of claim 15 wherein said sensing circuit comprises a surface wave acoustic (SAW) sensor circuit.

17. The device of claim 1 wherein said sensing circuit comprises a quartz crystal microbalance (QCM) sensor circuit.

18. The device of claim 1 further comprising a chemically selective membrane located between a source of said molecular contaminant and said material.

19. The device of claim 1 wherein said material is doped material.

20. The device of claim 19 wherein said material is doped with a specific molecule which interacts with a particular contaminant molecule.

21. The device of claim 19 wherein said material is doped aerogel material.

22. A method of monitoring molecular contamination, said method comprising:
providing a measurement element comprising a material having a surface area greater than 100 square meters per gram;
collecting molecular contamination on said surface area; and
electronically detecting said molecular contamination.

23. A method as in claim 22 wherein said electronically detecting comprises exciting an acoustic wave in said measurement element.

24. A method for monitoring molecular contamination, the method comprising:
providing a piezoelectric sensor;
locating a high-surface-area measurement element on said piezoelectric sensor; and
detecting a molecular contaminant on said measurement element.

25. The method of claim 24 wherein said detecting comprises generating an electrical signal indicative of an accumulated quantity of said received molecular contaminant on said measurement element.

26. The method of claim 25 wherein said detecting comprises exciting an acoustic wave in said piezoelectric sensor.

27. The method of claim 25 wherein said detecting comprises exciting an acoustic wave on the surface of said piezoelectric sensor.

28. The method of claim 25 further comprising inhibiting contaminants other than a selected molecular contaminant from reaching said measurement element.
